(19) United States
(12) Patent Application Publication
(10) Pub. No.: US 2003/0021111 A1
(43) Pub. Date: Jan. 30, 2003

(54) Multi-circuit tracklight system

(76) Inventors: Jack V. Miller, Seaford, DE (US); Ruth E. Miller, Seaford, DE (US)

Correspondence Address: JACK V. MILLER, 20915 Sussex Highway 13, Seaford, DE, 19973, US

(21) Appl. No.: 09/917,517

(22) Filed: Jul. 30, 2001

(51) Int. Cl. H01R 33/00

(52) U.S. Cl. 362/226; 362/238; 362/306

(57) ABSTRACT

A lighting track system according to the invention provides an elongated metallic track generally in the shape of an inverted U, with an elongated insulator extending through the track and including polarized pairs of neutral and power electrical conductors in one or more slots. A flexible cord and polarized plug electrically and mechanically connects to a pair of conductors in the track and prevents connection of the polarized plug with reversed polarity of the power and neutral conductors. In a preferred embodiment a polarized plug and cord is an end-feed that connects a track circuit to an electrical main circuit, or may connect a track circuit to a track-supported light fixture. In the preferred embodiment a polarized plug on each end of the flexible cord connects adjacent lengths of track. In the preferred embodiment a serrated ground engages a dovetail slot in the metallic track to ground track lengths and fixtures.

### BACKGROUND

1. Field of the Invention

This invention relates to the field of tracklights with positionable light fixtures electrically connected to track conductor pairs within an elongated inverted U-shaped track. Power for the fixtures is provided from an electrical junction box main, connected to the track through an-end feed connector. A number of luminaires are positionable along the track and are mechanically and electrically connected to the track conductors with fixture mounting adapters having track-to-luniinaire connectors. Where long lengths of track are needed, several sections of track are electrically connected together with track-to-track connectors. In addition to electrical power connections the tracklight system must be connected to a common ground.

2. Description of Prior Art

A popular tracklight system is shown in the applicant's U.S. Pat. No. 4,822,292 for a multiple-circuit track lighting system. Although it is unique in its multi-circuit selection simplicity, it is typical of prior-art tracklights in that it employs opposing electrical contacts on the fixture adapter that engage the track conductors in insulated slots on each depending leg of a U-shaped track. The fixture adapter is installed within the track in the space between the insulated track conductors above each luminaire. The basic disadvantages of prior-art tracklight systems is inherent unreliability due to the complexity of a series of single-contact electrical connections in the fixture adapter-to-track connectors, the track-to-track connectors and the track-to-end-feed connectors that supply line power from a remote source. Each of these connectors typically requires over a dozen parts. The system unreliability is also due to differential expansion and contraction of long lengths of tracks, resulting in relative movement of various straight and angular connectors against the track conductors. Another disadvantage of prior-art tracklights is the cost due to the complexity of the electrical and mechanical connections.

### OBJECTS OF THE PRESENT INVENTION

The principal object of the present invention is to provide a tracklight system: 1) that has greater reliability through redundant parallel contacts in fewer series electrical connections; 2) that does not have any differential movement of the track conductors and the connector contacts during temperature changes; and 3) that is less costly to manufacture due to fewer and simpler mechanical and electrical parts.

### BRIEF DESCRIPTION OF THE PRESENT INVENTION

The vast majority of lighting tracks are attached to ceilings, with a small percentage used on walls. Therefore the language in this disclosure uses the terminology of ceiling-mounted tracklight systems, wherein the base of the Ushaped track is generally horizontal and attachable to a ceiling, with the depending legs of the U extending downwards into a room.

The objects of the present invention are achieved by a tracklight system including an elongated metallic track generally in the shape of an inverted U, having a base attachable to a ceiling, and first and second parallel depending legs with proximal ends contiguous with the base of the U and having distal ends terminating in a common perpendicular plane. An elongated insulator is attached to at least one of the depending legs, each insulator having a number of pairs of longitudinal ribs having recesses therein. A partially-imbedded elongated electrical conductor is disposed in one side of each recess. Adjacent slots next to the ribs have unequal widths requiring polarized insertion of polarized electrical plugs.

In a preferred embodiment a polarized plug and cord is an end-feed that connects a track circuit to an electrical main circuit, or may connect a track circuit to a track-supported light fixture. In the preferred embodiment a polarized plug on each end of the flexible cord connects adjacent lengths of track. In the preferred embodiment a serrated ground engages a dovetail slot in the metallic track to ground track lengths and fixtures.

### ADVANTAGES OF THE PRESENT INVENTION

The present invention overcomes basic unreliability disadvantages of prior-art tracklight systems through the use of fewer and simpler mechanical and electrical parts. Reliability is also improved by eliminating the effects of differential expansion and contraction of long lengths of tracks, stopping relative movement between the track-to-track connectors and the track conductors. The track system according to the invention is less costly to manufacture, without the need for many complex stamped electrical parts and complicated insulators used in prior-art tracklights.

### BRIEF DESCRIPTION OF THE DRAWINGS

FIG. 1 is a transverse cross-sectional view of a prior-art two-circuit track according to the applicant's U.S. Pat. No. 4,822,292;

FIG. 2 is a transverse cross-sectional view of a prior-art track-to-fixture connector engageable into the track of FIG. 1;

FIG. 3 is a perspective view of a prior-art end-feed connector engageable into the track of FIG. 1;

FIG. 4 is a perspective exploded view of the parts of the prior-art end-feed connector of FIG. 3;

FIG. 5 is a perspective view of a prior-art track-to-track connector engageable into the track of FIG. 1;

FIG. 6 is a perspective exploded view of the parts of the prior-art track-totrack connector of FIG. 5;

FIG. 7 is a transverse cross-sectional view of a track according to the present invention;

FIG. 8 is a perspective view of a polarized plug engageable with the first circuit conductors of the track of FIG. 7;

FIG. 9 is a perspective view of a polarized plug and flexible cord engageable into the first circuit track of FIG. 7 to serve as an end-feed junction-box-to-track connector or a track-to-fixture connector;

FIG. 10 is a perspective view of a polarized plug and flexible cord engageable into the second circuit track of FIG. 7 to serve as an end-feed junction-box-totrack connector or a track-to-fixture connector;

FIG. 11 is a transverse cross-sectional view of the track according to the present invention showing an installed polarized plug and cord of FIG. 9;

FIG. 12 is a transverse cross-sectional view of the track according to the present invention showing an installed polarized plug and cord of FIG. 10;

FIG. 13 is a perspective view of a polarized plug jumper cord engageable into the track of FIG. 7 to serve as a track-to-track connector;

FIG. 14 is a perspective partial cross-sectional view of a track according to the present invention, showing track-to-fixture, track-to-track and end-feed track-tojunction-box connections.

FIG. 15 is a perspective partial cross-sectional view of a track according to the present invention, showing a mitered track connection including track-to-track, track-to-fixture and grounding connections;

FIG. 16 is a perspective view of a grounding conductor according to the present invention;

FIG. 17 is a longitudinal cross-sectional view of the grounding conductor of FIG. 16; and

FIG. 18 is a longitudinal cross-sectional view of an angular grounding conductor for mitered track connection.

### REFERENCE NUMERALS IN DRAWINGS

1 prior-art track

2 track extrusion

3 insulator

4 conductor

6 fixture adapter and connector

7 first contact blade

8 second contact blade

9 luminaire wires

10 locking mechanism

11 luminaire mounting shaft

12 prior-art end-feed connector

14 prior-art track-to-track connector

21 present invention track

22 track extrusion

23 base of extrusion U

24 first depending leg

25 second depending leg

26 distal end of first leg

27 distal end of second leg

28 contiguous rib

29 elongated insulator

30 first rib pair recess

31 second rib pair recess

32 first inner wall

33 second inner walls

34 first (wide) slot

35 second (narrow) slot

36a, 36b power conductors

37 neutral conductor

38 polarized electrical plug

39 plug first outer (thin) blade

40 plug second outer (thick) rib

41 plug inner rib

42 first resilient electrical contact

43 second resilient electrical contact

45 polarized cord and plug

47 flexible wires

48 crimp connections

49 jumper cable

50 power wire

51 neutral wire

52 crimp connections

53 fixture mounting adapter

54 first track length

55 second track length

56 third track length

57 first straight track length

58 first mitered track length

59 second mitered track length

60 second straight track length

61 serrated grounding connector

62 ground serration teeth

63 wire attachment spade

64 miter ground connector

### DETAILED DESCRIPTION OF THE DRAWINGS

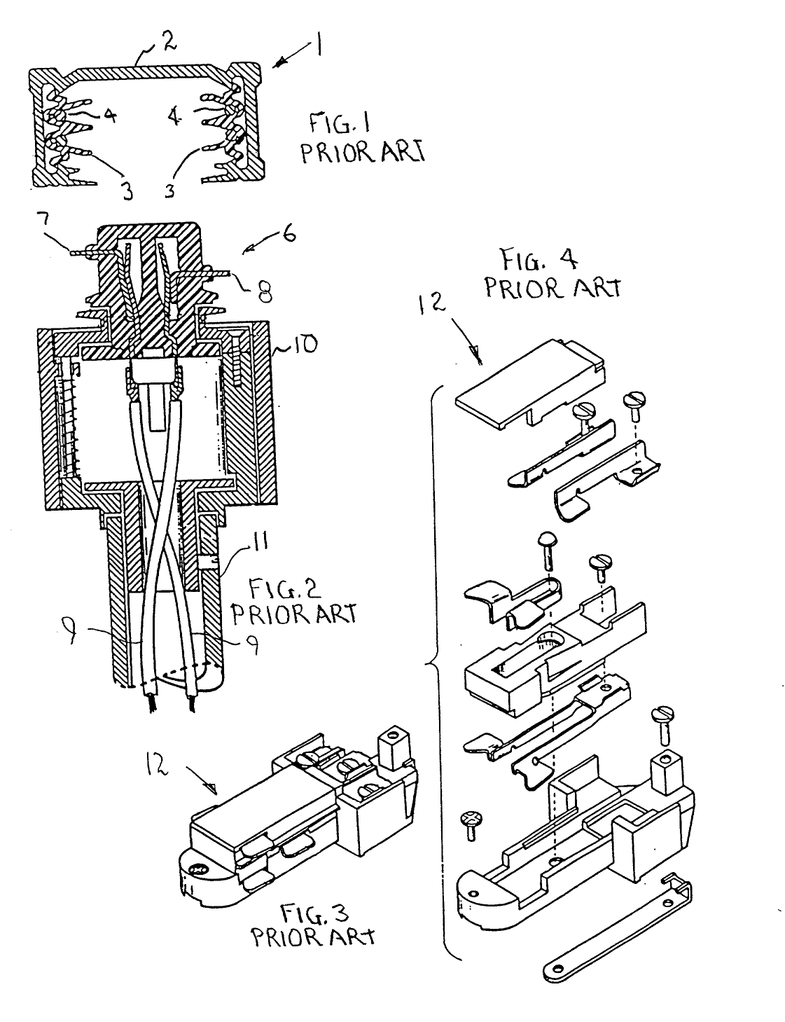

In FIG. 1 transverse cross-sectional view of a prior-art track 1 according to the applicant's U.S. Pat. No. 4,822,292 is shown having an elongated. generally “C” shaped metal track extrusion 2 enclosing a pair of insulators 3, that in turn retain conductors 4.

In FIG. 2 a fixture mounting adapter and luminaire-to-track connector 6 may be inserted into track 1 and twisted to resiliently engage a pair of contact blades 7 and 8 with selected track conductors 4. A locking device 10 and trunnion vertical axle 11 depend downward below the track to receive a transverse trunnion element (not shown). To select the second circuit the fixture mounting adapter is twisted out of the track, rotated 180° and re-inserted and twist locked into position.

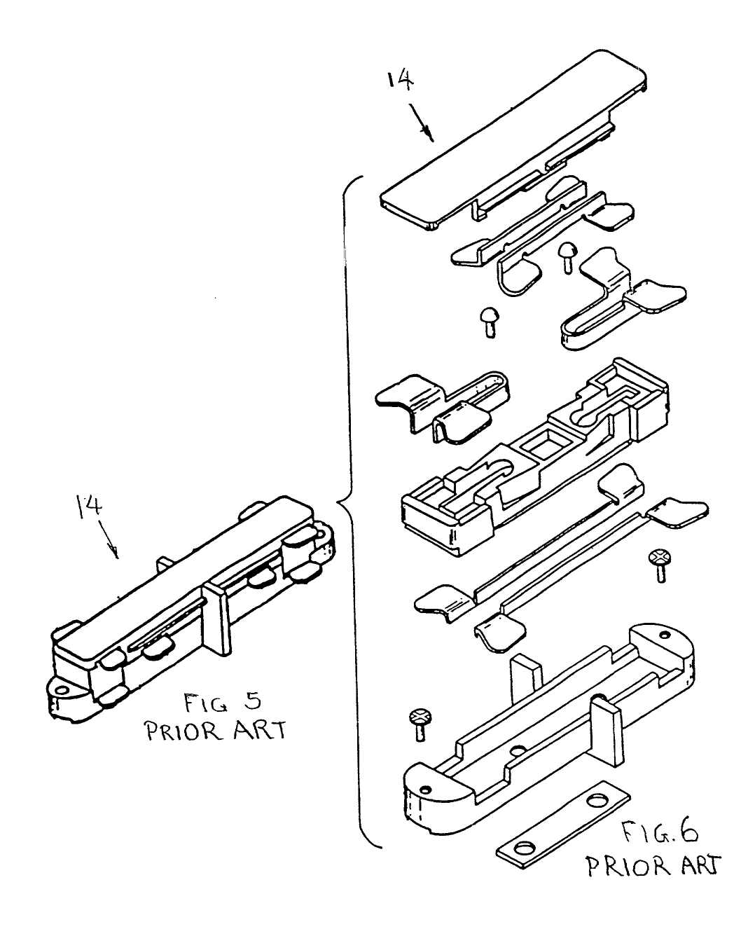

In FIG. 3 a prior-art end feed connector 12 is shown. In FIG. 4 connector 12 is shown as an exploded view, showing the complexity of the connector.

In FIG. 5 a prior-art track-to-track connector 14 is shown in perspective.

In FIG. 6 track-to-track connector 14 is also shown in an exploded perspective view, showing the complexity of the connector.

In FIG. 7 a track 22 according to the present invention is a metal extrusion 21 generally in the shape of a U, having a base 23 and first and second parallel depending legs 24 and 25 with distal ends 26 and 27.

An elongated insulator 29 is retained in a channel formed by base 23, depending leg 24 and a contiguous, horizontal, distal rib 28. Insulator 29 has a number recesses 30, 31 between pairs of cantilevered ribs extending towards leg 25, each such rib having inner walls 32,33, and each wall including a partiallyembedded first and second circuit power conductors 36a, 36b, respectively, and neutral conductors 37 (which are electrically common). The rib pairs are bounded by outer slots 35 and an inner and wider slot 34.

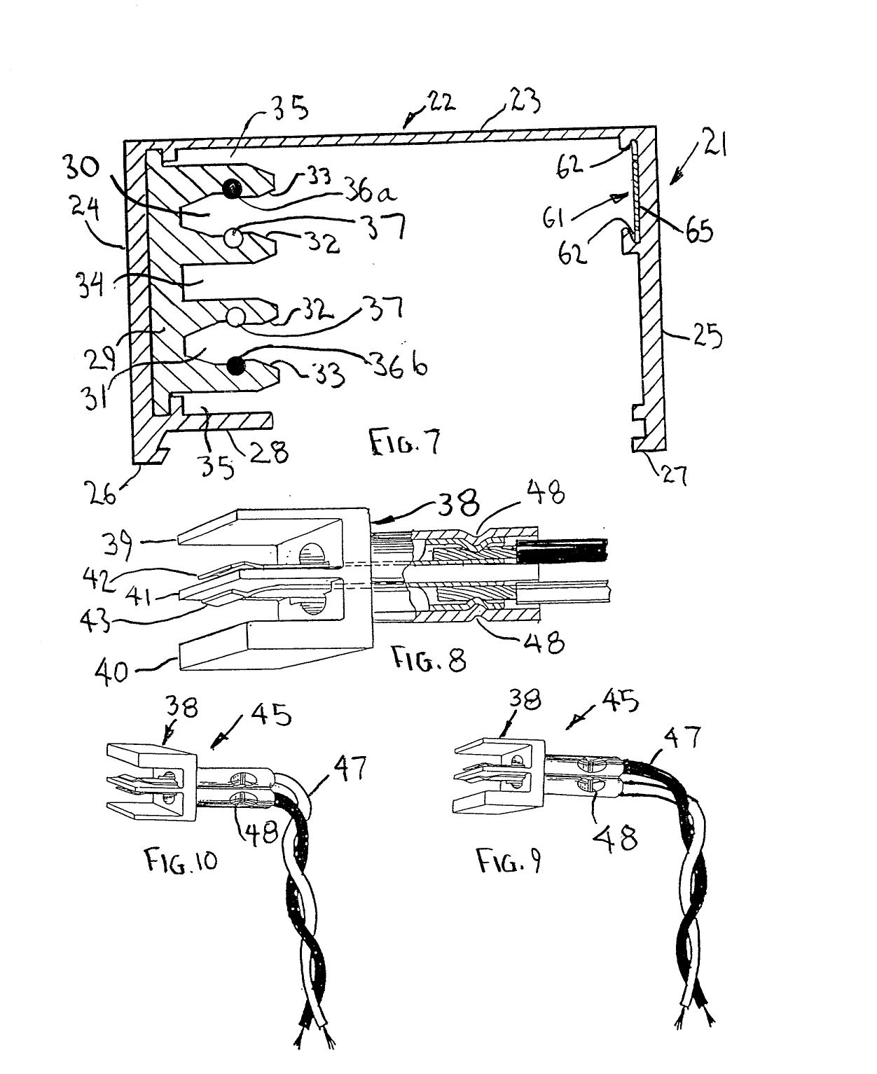

In FIG. 8 a polarized, generally E-shaped electrical plug 38 includes a first outer rib 39 and a second outer rib 40, which is substantially thicker than rib 39 and slots 35 of FIG. 7. An inner rib 41 includes first and second resilient electrical contacts 42, 43, that are mechanically and electrically engageable respectively with power track conductor 36a or 36b and a neutral track conductor 37. Contact can be made only when wide rib 40 can enter slot 34 to assure correct conductor polarity.

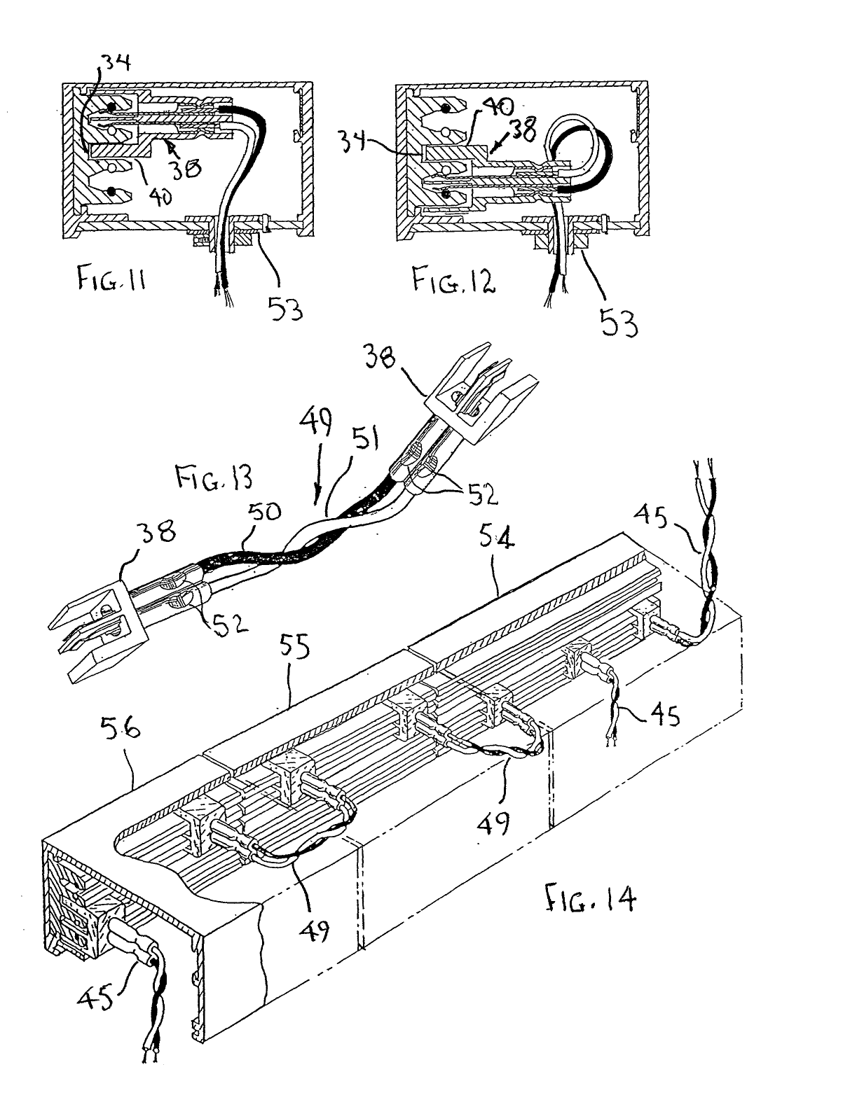

FIGS. 9, 10, 11 and 12 illustrate how the wide rib 40 of polarized plug 38 must always enter slot 34 to permit only proper polarity of the conductors and wires, shown in the required color code of black for power and white for neutral. FIG. 11 illustrates connection to a first power circuit using power conductor 36a and FIG. 12 illustrates connection to a second power circuit using power conductor 36b. Wires 47 are shown going through a fixture adapter 53.

In FIG. 13 a plug 38 is shown connected on each end of a pair of insulated wires 50 and 51 with crimp connections 48, forming a polarized jumper cable 49 with the white neutral wire always next to the wide rib that can only enter slot 34 adjacent the neutral track conductors.

As shown in FIG. 14 a first track length 54 (shown with a very short length for clarity) is end-feed connected with proper polarization through a cord and plug 45 to an external source of mains power. Either one or two polarized cord-and-plug connectors 45 may be plugged into the first and/or second circuits to energize the tracks. Any number of polarized cord-and-plug connectors 45 may be used to power light fixtures along the tracks, within the ampacity of each circuit. One or more polarized jumper cords 49 can connect either or both circuits as track-to-track connectors, or they may be used to transfer one circuit to another circuit in one or two adjacent track lengths. With various tracklight fixtures connected to any circuit desired. Simpler or more complex multi-circuit tracks may be made with one, two or several circuits for more complex installations. This allows more flexibility in ampacity and in switching arrangements for utility and energy conservation.

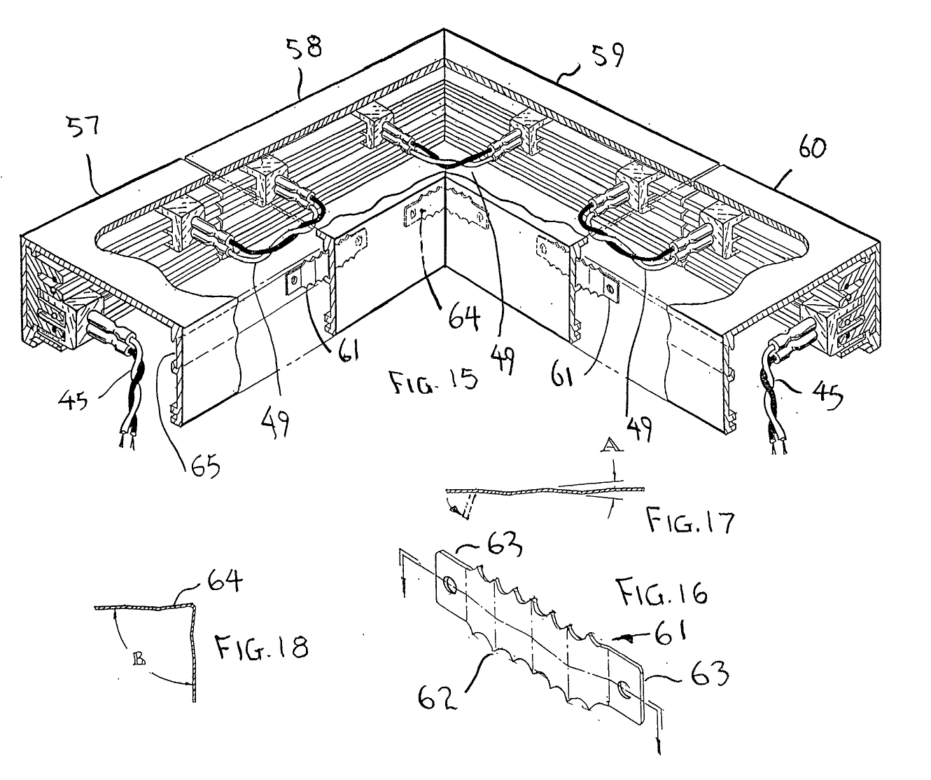

In FIG. 15 a track miter joint is shown, wherein several straight track sections are used and joined in a 90° miter joint between track section 58 and 59, all with polarized jumper cables 49, and feeding track fixtures through polarized cord-and-plug connectors 45. System grounding is also illustrated with serrated ground conductors 61 as shown in detail in FIGS. 16 and 17. A miter-joint ground conductor 64 is shown as illustrated in FIG. 18.

Referring again to FIGS. 16 and 17, ground conductor 61 has serrated teeth 62 along a length having wave angles “A” to urge the serrated teeth into conductive engagement with the sides of a T-slot channel 65 of FIG. 15. The ends of ground conductor 61 are male spade tabs suited to wire attachment either with crimp-on female spade connectors of soldered wires. A tab may be bent appropriately, as seen in FIG. 17 for wire attachment.

In FIG. 18 a miter ground conductor 64 is shown as a conductor 61 bent at angle “B” to suit whatever track miter angle is required.

### OPERATION, RAMIFICATIONS AND SCOPE

In operation the present invention provides great versatility with a very few parts in an inexpensive tracklight system. With a two-circuit track as described and illustrated, three-way operation may be achieved with some luminaires plugged into a first circuit, operated from a first switch; and other luminaires plugged into a second circuit, operated from a second switch. The switches for one bank of lights may be turned on for low-level lighting, a second bank of lights may be turned on for an intermediate lighting level, and both banks of lights may be turned on for a high level of illumination. Thus an entire room or any large area may achieve three-way dimming operation from a simple pair of wall switches or a conventional three-way switch, without the need for complex and expensive electronic dimming controls.

A single luminaire may be connected to two switched circuits to use a threeway lamp or a pair of single incandescent, fluorescent or other gas-discharge lamps, or any mix thereof. It is well-known that dimming halogen-cycle lamps dramatically drops both lumen efficiency and color temperature, wasting electrical power and degrading lighting aesthetics. By connecting a single luminaire with two polarized plugs plugged into different circuits, it is simple and inexpensive to dim a two-lamp halogen luminaire, with two different lamp wattages, while maintaining constant lamp color temperature and without losing the halogen cycle required for normal lamp life. Thus if a 50-watt halogen lamp is paired in a luminaire with a 100-watt halogen lamp, the three-way operation can be 50, 100 or 150 watts without a dimmer, and with a constant 3000° K. color temperature.

Similarly, a 9-watt compact fluorescent lamp may be paired with a 26-watt compact fluorescent lamp the luminaire can be a 9-watt nightlight or security light, a 26-watt intermediate output luminaire or a 35-watt luminaire that is equivalent to current 35-watt, 4-foot T-8 fluorescent lamp, in a straight or U-lamp configuration.

Further, metal-halide lamps have a time-delayed restrike if a short power outage occurs. If the metal-halide lamp luminaire also contains a compact fluorescent lamp or small quartz-halogen lamp, it provides safety lighting during the metal-halide lamp restrike and warm-up time period. The inclusion of a compact fluorescent lamp in a metal-halide fixture also will provide efficient nightlight and security light operation in a single tracklight fixture.

Another operational advantage is in the ability to include both a metalhalide lamp and a quartz-halogen lamp in the same luminaire to improve the typical poor color-rendition index of the metal halide lamp.

The present invention overcomes the disadvantages in complexity, reliability and cost of prior-art tracklight systems, providing significant advantages to users in ordering, costs, installing and maintaining these lighting systems. Of course, the unique principles of the present invention may be applied to many variations of tracklights which will fall under the claims herein. For instance, the track may have one, two, three, four or more individually-polarized pairs of slots, with conductors fed from several junction-box mains at various locations. With only one circuit the track can have a flat aspect ratio or can have a wire-way channel on the top surface of the U extrusion. Further, the track can have two insulators carrying polarized slots and their respective conductors of both depending legs to multiply current-carrying for more luminaires plugged in with more polarized plugs in more pairs of slots.

1. A lighting track system comprising:
an elongated track generally in the shape of a U, having a base and first and second parallel depending legs having distal ends in a common plane;
a contiguous, horizontal rib extending from the distal end of the first leg towards the second leg, forming an elongated channel with the first leg and the base of the inverted U;
an elongated insulator within said elongated channel, said insulator having one or more pairs of cantilevered ribs extending towards the second leg, each pair of ribs including inner walls forming a recess having a base and first and second internal walls;
a first and second slot adjacent the outer walls of each pair of cantilevered ribs, the first slot being substantially wider than the second slot;
a partially-imbedded elongated electrical power conductor in one inner wall and a neutral conductor in the other wall of each recess between a pair of cantilevered ribs of the elongated insulator;
a number of polarized electrical plugs, each including a generally Eshaped insulator comprising a base and first outer rib, a second outer rib substantially thicker than the first outer rib, said second outer rib also being substantially thicker than the second slot adjacent the cantilevered ribs, and an inner rib including first and second resilient electrical contacts electrically and mechanically engageable with the first and second electrical conductors in a recess formed by the ribs of the elongated insulator; and
a pair of flexible wires connected to the resilient electrical contacts of one polarized plug and extending out of the base of the plug for an end-feed connection to a first power-and-neutral pair of electrical mains.

2. A lighting track system according to claim 1 in which the wires extending out of the polarized plug are adapted for connection to a lighting fixture supported by the track.

3. A lighting track system according to claim 1 in which the wires extending out of the polarized plug are connected to a second identical polarized plug engageable into another polarized pair of elongated electrical conductors in the elongated insulator of a single length of track.

4. A lighting track system according to claim 1 in which the wires extending out of the polarized plug in a first length of track are connected to a second identical polarized plug engageable into another polarized pair of elongated electrical conductors the elongated insulator of a second length of track.

5. A lighting track system according to claim 1 in which the second parallel leg of the metallic track includes an inward-facing dovetail slot configured to retain a serrated grounding conductor having teeth engaging the slot.

6. A lighting track system according to claim 1 in which the second parallel leg of the metallic track includes an inward-facing dovetail slot configured to retain a serrated grounding conductor, said serrated grounding conductor being elongated and having teeth engaging slot, said grounding connector including a flexible wire attachment to an external ground.

7. A lighting track system according to claim 1 in which the second parallel leg of the metallic track includes an inward-facing dovetail slot configured to retain a serrated grounding conductor, said serrated grounding conductor being elongated and having teeth engaging and grounding together the slots in two abutting lengths of track.

8. A lighting track system according to claim 1 in which the second leg of the track includes an inward-facing dovetail slot configured to retain a serrated grounding conductor, said serrated grounding conductor being elongated and having teeth engaging the slot, said grounding connector including a flexible wire for connection to a lighting fixture supported by the track.

9. A lighting track system according to claim 1 in which the second parallel leg of the metallic track includes an inward-facing dovetail slot configured to retain a serrated grounding conductor, said serrated grounding conductor being elongated, in the form of an angle, and having teeth engaging and grounding together the slots in two abutting mitered lengths of track intersecting at the same angle.

10. A lighting track system comprising:
an elongated metallic track generally in the shape of an inverted U and havinbg an elongated insulator extending through the track including polarized pairs of neutral and power conductors in one or more recesses;
at least one flexible cord having a polarized plug at each end, electrically and mechanically connectable to a pair of conductors in adjacent tracks;
at least one flexible cord having a polarized plug at one end, electrically and mechanically connectable to a pair of conductors the track and connectable to a light fixture or connecting a track to power mains; and
means for preventing connection of the polarized plug with reversed polarity of the power and neutral conductors.

11. A lighting track system according to claim 1O in which a T-slot is provided in the inside of the track U and a serrated ground conductor engages and grounds track lengths that are adjacent to each other or adjacent to a grounded end-feed power mains junction box.
